(19) United States
(12) Patent Application Publication
(10) Pub. No.: US 2005/0111295 A1
(43) Pub. Date: May 26, 2005

(54) Horizontal kneading machine for edible dough, particularly for oven-baked products

(75) Inventor: Davide Drocco, Alba (Cuneo) (IT)

Correspondence Address: SUGHRUE MION, PLLC, 2100 PENNSYLVANIA AVENUE, N.W., SUITE 800, WASHINGTON, DC, 20037, US

(73) Assignee: SANCASSIANO S.P.A.

(21) Appl. No.: 10/978,467

(22) Filed: Nov. 2, 2004

(30) Foreign Application Priority Data
Nov. 3, 2003 (IT) TO2003A000863

(51) Int. Cl. A21C 1/06; B29B 7/00; B01F 7/00

(52) U.S. Cl. 366/97; 366/297

(57) ABSTRACT

A horizontal kneading machine is described herein, having a tank and two kneading tools rotatable with concurrent directions of rotation around two horizontal and parallel axes inside the tank in such a way as to define two mutually tangential theoretical cylinders. Each kneading tool comprise a kneading arm substantially rectilinear and positioned along a direction that substantially coincides with a generatrix of the respective theoretical cylinder, or is slightly inclined relative thereto.

### BACKGROUND OF THE INVENTION

The present invention relates to kneading machines for edible doughs, particularly for oven-baked products, of the type comprising a tank, and at least two kneading tools rotatable within the tank around two substantially horizontal and parallel axes.

Kneading machines having the above characteristics are also defined simply “horizontal kneading machines”. Examples of machines of this kind are illustrated in the documents U.S. Pat. No. 4,883,361, U.S. Pat. No. 2,050,654, U.S. Pat. No. 4,269,582. Such known devices use two counter-rotating kneading tools and typically work according to a continuous process.

One of the objects of the present invention is to provide a horizontal kneading machine, able to be designed and built instead of as a “continuous” machine also, if desired, as a machine operating in batches, i.e. with a tank that is filled every time with the ingredients needed to obtain a determined quantity of mixture and which is emptied once the mixture is obtained, to allow working a new batch of mixture.

Another object of the present invention is to provide a horizontal kneading machine that is able to obtain a high quality mixture in a relatively short time.

The correct execution of the mixture is a critical problem, having to meet a multiplicity of needs. On the quality of the mixture depends to a considerable extent the very quality of the oven-baked products obtained by cooking the dough. It is wholly evident that it is necessary for the kneading action to take place in consistent fashion throughout the mixture mass. Moreover, it is essential for the kneading work to be maintained to a minimal value, i.e. for the efficiency of the machine to be very high. This is required for obvious energy savings needs and to limit stresses on the kneading tools, thus also influencing the sizing of the organs of the apparatus. Moreover, the kneading work is resolved in a transfer of corresponding energy to the mass of the dough, with a consequent rise in its temperature.

It should also be noted that it is beneficial for the dough to be “cut”, i.e. divided by the kneading tools, during the kneading operation, because this action is important to activate the enzymatic reactions of the dough. However, this cutting action must not be obtained with a high speed of the kneading tools, which would entail an unacceptable increase in the kneading work and excessive stressing of the mixture mass.

Therefore, an additional object of the invention is to provide a horizontal kneading machine of the type set out above which gives rise to an action of cutting the mixture mass during the kneading operation, in order to allow an optimal development of the mixture, providing for contact with the atmosphere of ample surfaces of the mixture mass and further causing an action of stretching and opening the mixture which increases its oxygenation.

### SUMMARY OF THE INVENTION

In view of achieving the above objects, the invention relates to a kneading machine comprising a tank and at least two kneading tools rotatable within the tank around two substantially horizontal axes, characterised in that:
the two kneading tools are rotatable within the tank with concurring directions of rotation,
the two kneading tools define, with their rotation, two theoretical cylinders, substantially tangential to each other,
each kneading tool has an arm that extends substantially on the periphery of the respective theoretical cylinder, so that said arm performs an orbital movement around the respective axis of rotation,
each arm, at least for a substantial part of its length, is substantially rectilinear and positioned along a direction that substantially coincides with a generatrix of the respective theoretical cylinder, or is slightly inclined relative to said generatrix.

Preferably, the orbital movements of said arms around the respective axes of rotation are mutually synchronised, in such a way that the arms pass substantially simultaneously in the area of tangency of their theoretical cylinders, crossing each other with opposite directions of motion, because of the concurrent rotation of the two tools.

Thanks to the aforesaid characteristics, the kneading machine according to the invention is able to produce a mixture of excellent quality. This is due in particular to the cutting action whereto the mixture is subjected every time the two arms of the kneading tools pass in the tangency area of the respective theoretical cylinders, crossing each other with opposite directions of motion.

It should be noted that the provision of two kneading tools having the above characteristics has already been disclosed in the Applicant's prior European patent application EP 1 342 501 A2. This document protects the general principle of the arrangement described above of the kneading tools, independently of the type of machine. However, it illustrates, by way of example, an embodiment in which the two kneading tools are rotatable around two vertical axes around a cylindrical tank, which also has vertical axis.

The present invention essentially consists of the idea of applying the specific shape and mutual arrangement of the two kneading tools which was the subject of the previous European patent application identified above to a horizontal kneading machine, in order to obtain in combination, the advantages linked to obtaining the cutting effect described above with the specific advantages of a horizontal kneading machine. It should be noted in particular that the aforesaid application results in a horizontal kneading machine of new conception, having two kneading tools, both rotatable in the same direction, which are capable of operating both in a machine working in batches, and in a continuously working machine.

If the invention is applied to a horizontal kneading machine operating in batches, the kneading tank will preferably be provided with means for emptying it. In the case of a continuously operating machine, the tank will have elongated conformation, with one end that receives the ingredients of the mixture, or a pre-mixed product, and the opposite end with an outlet wherefrom a continuous loaf of mixture is emitted. In this case, the advance of the mixture along the tank is obtained not by effect of the kneading tools, but simply by effect of the thrust exerted by the new product which presses at the inlet of the machine.

Further advantageous characteristics of preferred embodiments of the machine according to the invention are set out in the appended claims.

### BRIEF DESCRIPTION OF THE DRAWINGS

The invention shall now be described with reference to the accompanying drawings, provided purely by way of non limiting example, in which:

FIG. 1 is partially sectioned end view of a preferred embodiment of the machine according to the invention,

FIG. 2 is a lateral view of the machine, also partially sectioned according to the line II-II of FIG. 1,

FIG. 3 is a plan view, partially sectioned according to the line III-III of FIG. 1,

FIG. 3A schematically shows the system for transmitting the rotation of the two kneading tools,

FIGS. 4, 5 show two possible variants of the shape of the tank of the machine according to the invention and,

FIGS. 6-9 show four different embodiments of the kneading tools of the machine according to the invention.

### DETAILED DESCRIPTION OF THE INVENTION

In the drawings, the reference number 1 globally designates a horizontal kneading machine, comprising a fixed support structure 2 which in the illustrated example includes a base 3 surmounted by a frame including columns 4 superiorly connected by cross members 5, 6.

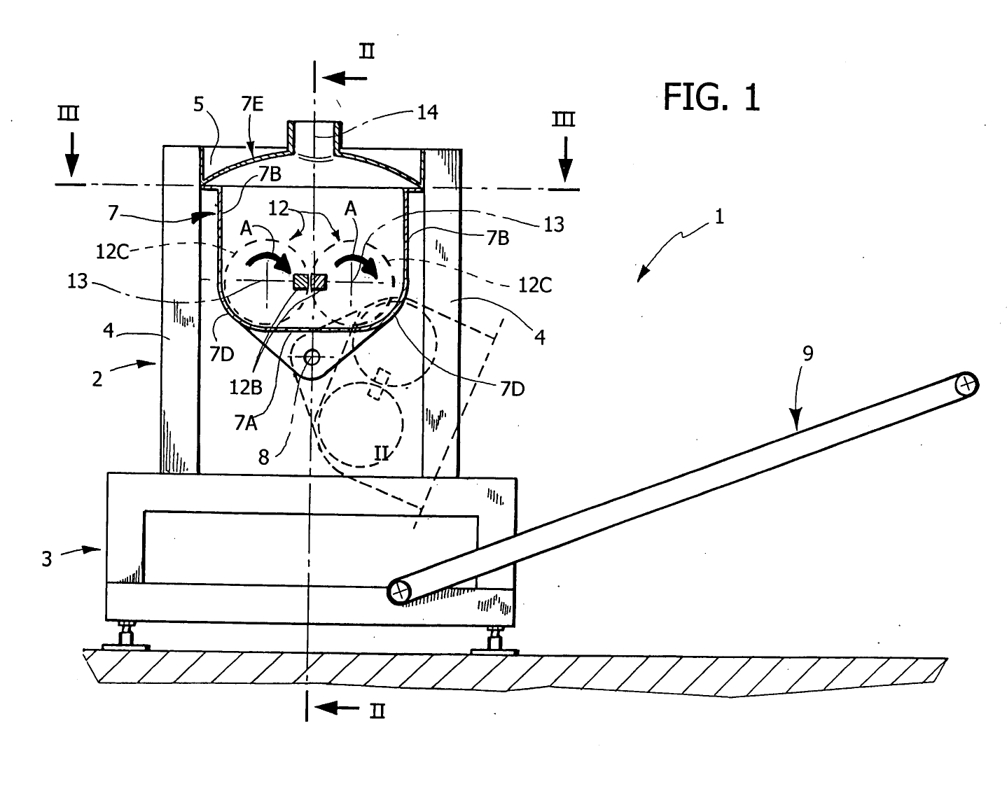

The fixed structure 2 supports a tank 7 for the mixture having a bottom wall 7a (which in the illustrated example is planar), the two longitudinal lateral walls 7B, planar and vertical, and two end walls 7C which are also planar and vertical and arranged in planes that are orthogonal to the planes of the longitudinal walls 7B. Naturally, the shape of the tank illustrated herein is merely an example of embodiment of the invention, said shape also being able to be wholly different from the preferred shape described herein. Still with reference to FIG. 1, the bottom wall 7A is connected to the two longitudinal walls 7B by means of two curved walls 7D, with substantially circular profile.

The example of machine illustrated herein refers to the case of a machine destined to operate in batches, i.e. in which the kneading tank is emptied of the kneaded product at the end of the kneading cycle, thereby being readied to receive the product necessary for a new mixture. Consequently, in the illustrated example, the kneading tank is provided with means able to empty it of its content. By way of example, again the case illustrated herein, the tank 7 is supported for this purpose on the fixed structure 2 in oscillating fashion around a longitudinal axis 8 and it is therefore movable between a normal operative condition, illustrated in solid lines in FIG. 1, and a rotated condition (illustrated with dashed line in FIG. 1) in which the product contained in the tank is poured on a conveyor belt 9 which carries the kneaded product towards the discharge of the machine. Naturally, in theory any other means for emptying the tank can be provided.

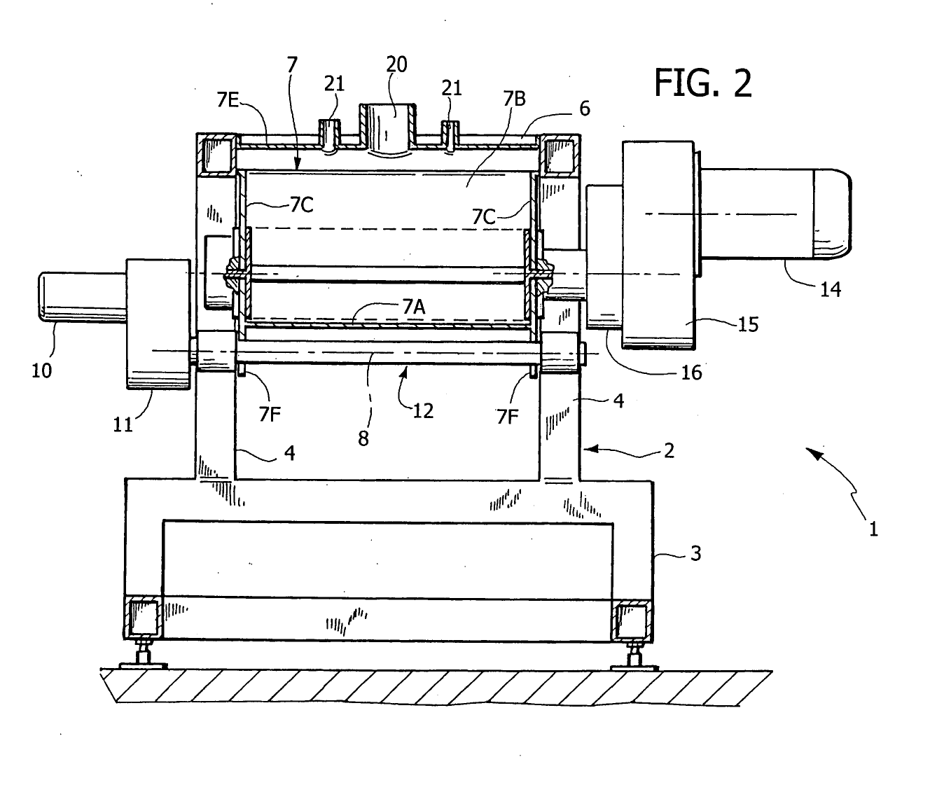

As shown in FIG. 2, to the fixed structure 2 is anchored a command assembly including an electric motor 10 and a reduction set 11 for actuating a shaft 12 which is mounted rotatable on the fixed structure 2 around the axis 8 of tilt of the tank. The structure of the tank is anchored to the shaft 8, by means of flanges 7F (FIG. 2) in such a way that a rotation of the motor 10 causes a consequent oscillation of the tank between its operative position and its tilted position.

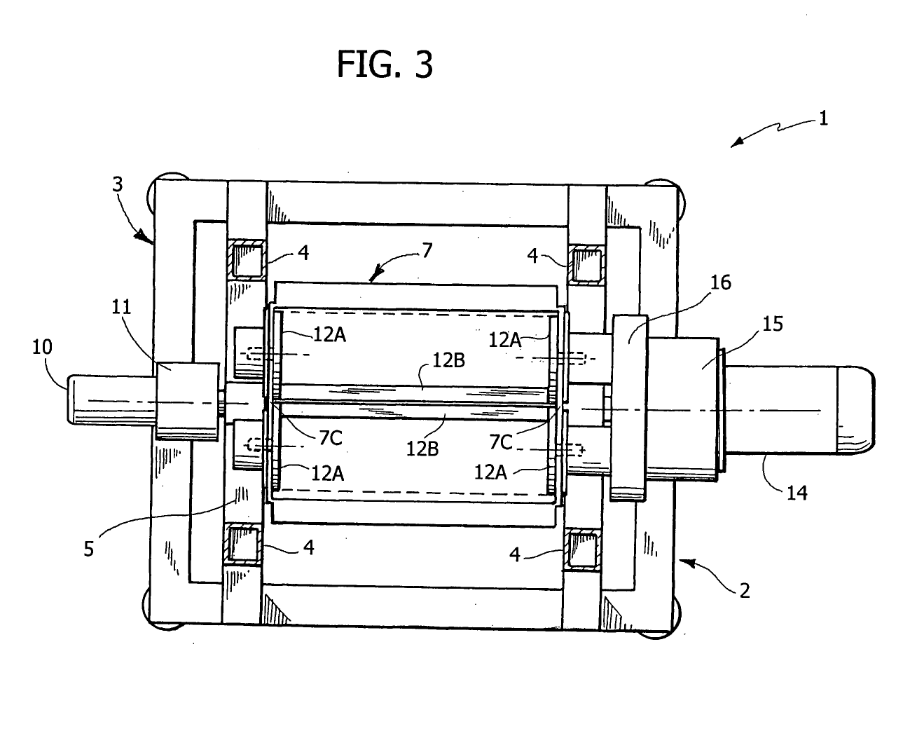

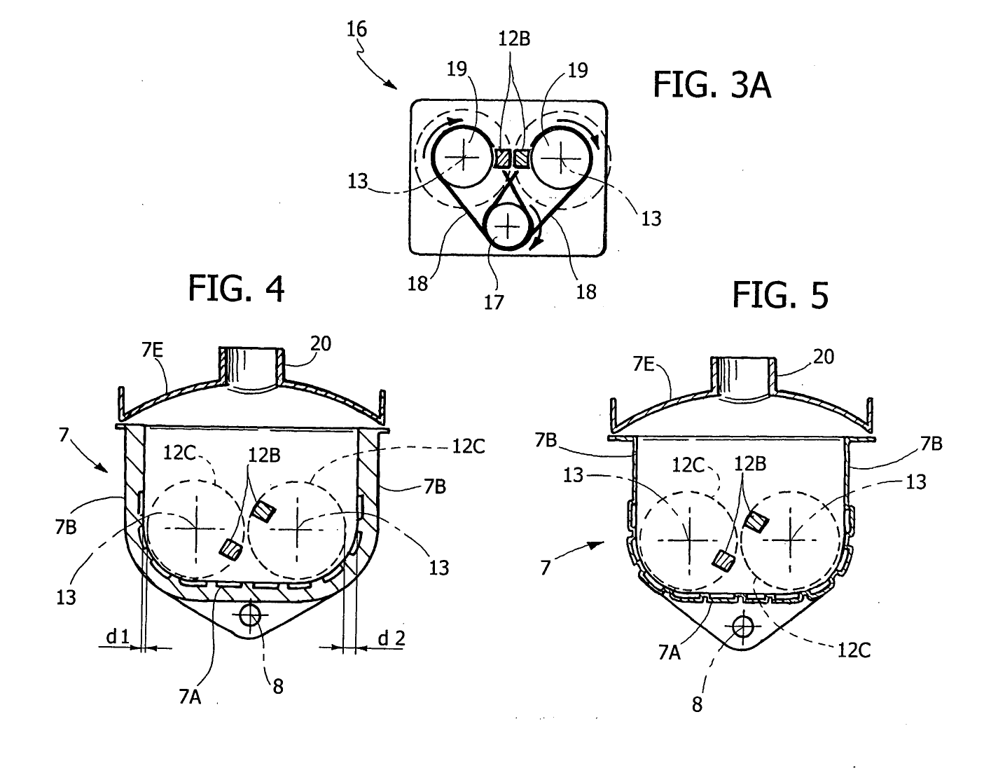

The structure of the tank 7 supports two kneading tools 12 in rotatable fashion around the two horizontal axes 13 positioned symmetrically to the two sides of the longitudinal median plane 14 (FIG. 1) of the tank 7. Each of the kneading tools 12 comprises two end disks 12A orthogonal to the respective axis 13 and having hubs mounted rotatable around the axis 13 on the respective end walls 7C of the tank 7. Preferably, contrary to what is illustrated herein, each disk is positioned within a recessed cavity of the respective wall 7C, in such was as not to project into the cavity of the wall. The two end disks 12A of each kneading tool 12 are mutually joined by a longitudinal arm 12B which in the illustrated example has a substantially quadrangular section and which extends in a rectilinear direction parallel to the horizontal axes of rotation 13. The rotation of the two kneading tools 12 is actuated by an electric motor 14 by means of a reduction set 15 and a gearbox 16, shown in section view in FIG. 3A. The rotation of the output shaft of the gearmotor set 14, 15 is transmitted by a pulley 17 which keyed on said output shaft to two pulleys 19 keyed on end shafts connected to the two kneading tools 12, by means of two belts 18. As shown in the drawings, the rotation of each kneading tools therefore causes an orbital motion of each arm 12B around the respective axis of rotation 13. During said movement, each arm 12B therefore describes a theoretical cylinder 12C with its axis coinciding with the axis of rotation 13. The two theoretical cylinders 12C of the two kneading tools are substantially tangential to each other (FIG. 1). Moreover, in the case of the preferred embodiment illustrated herein, the two theoretical cylinders 12 are also both tangential to the bottom wall 7A of the tank 7. Lastly, again in the case of the illustrated embodiment, the curved walls 7D can be substantially concentric and immediately adjacent to the two theoretical cylinders 12C of the kneading tools 12.

A further important characteristic of the invention resides in the fact that the means for actuating the kneading tools are arranged to actuate a synchronised rotation of the two tools 12 in the same direction (see arrows A in FIG. 1). Moreover, in the case of the preferred embodiment, the two arms 12B are mutually “in phase” so they reach in substantially simultaneous fashion the area of tangency of the two theoretical cylinders 12C of the kneading tools. Therefore, during the operation of the machine, at each rotation turn of the kneading tools the two arms 12B cross each other simultaneously in the area of tangency of the two theoretical cylinders 12C with opposite directions of motion (due to the rotation of the two tools in the same direction) which gives rise to a cutting and opening action on the mixture which produces benefits discussed in the preamble of the present description.

Naturally, it would also be possible to provide for the phase of the two tools 12 to be such that the arms 12B reach the area of tangency of the two theoretical cylinders 12B at non-coinciding, but close times. Lastly, means can be provided for a regulation of the mutual phase of the rotations of the two tools 12.

Still with reference to FIGS. 1, 2, the tank 7 is preferably provided with a lid 7E which is provided with manifolds 20, 21 for the introduction of the ingredients needed for the mixture. Use of a lid also allows to connect the cavity inside the tank to a source of vacuum or pressure if the mixture is to be obtained in a vacuum or under pressure, according to a known technique.

FIG. 4 shows an embodiment of the tank 7 in which the wall of the tank includes a cooling jacket in which a cooling fluid is made to circulate in order to control the temperature of the kneaded product. As shown in said figure, as well as in FIG. 1, in this embodiment the distances d1 and d2 of the two theoretical cylinders 12C from the lateral walls 7B are different. FIG. 5 shows a variant, in which the distances d1 and d2 are substantially identical and the two theoretical cylinders 12C are tangential respectively to the two longitudinal lateral walls 7B.

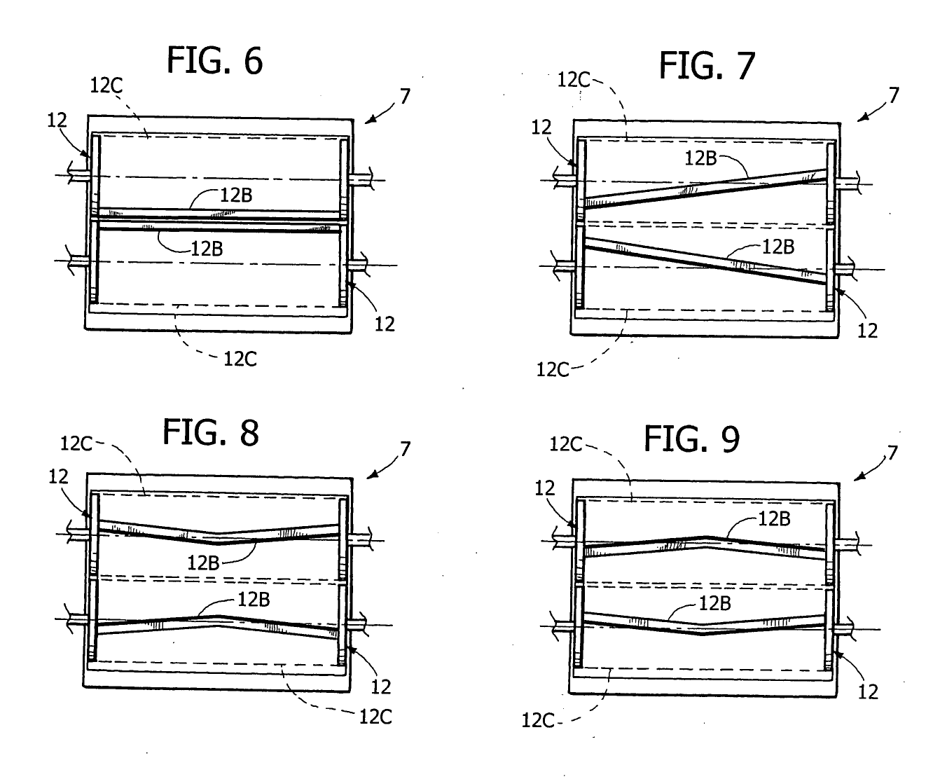

FIG. 6 schematically shows a plan view of the kneading tank 7, with the two kneading tools 12. FIG. 7 shows a variant in which each of the arms 12B instead of extending in rectilinear direction along a generatrix of the respective theoretical cylinder 12C, as in FIG. 6, extends according to a rectilinear direction inclined relative to the generatrix.

Thanks to the inclined arrangement shown in FIG. 7 of the two arms 12B, the cutting action exerted by the kneading tools 12 on the mixture on the occasion of each crossing of the two arms 12B is more progressive and similar to a “scissors” effect. The counterpart of said advantage is that the inclined arrangement of the arms gives rise to a thrusting action exerted by the kneading tool on the dough in the direction of an end of the tank.

FIGS. 8, 9 show two additional variants in which the kneading arms 12B have a broken line profile with two segments inclined in opposite directions. Said positions have the advantage of preserving the progressive effect of the cutting action, characteristic of the solution of FIG. 7 without introducing thrusting actions on the dough in the axial direction, since the effects produced by the two differently inclined portions of each arm 12B offset each other. The solutions of FIGS. 8, 9 differ from each other because the aforesaid broken line defines an arrow oriented in the direction of rotation of the tool or in the opposite direction.

During the operation of the machine according to the invention, the products needed for the mixture are introduced into the kneading tank through the manifolds 20, 21, whereupon the two kneading tools 12 are set in synchronous and concurrent rotation by means of the motor 14, the reduction unit 15 and the gearbox 16. Naturally, the arrangement of the gearbox 16 described above is provided herein purely by way of example, since for example a gear transmission or any other type of transmission can be provided. Following the rotation of the kneading tools, the mixture is obtained. Every time the two arms 12B cross in correspondence with the area of tangency between the two theoretical cylinders 12C, the dough is “cut” and opened, achieving the benefits discussed above. At the end of the kneading step, the kneading tools are stopped and the motor 10 is activated to discharge the obtained mixture on the conveyor belt 9.

An identical configuration could also be adopted for a machine able to operate continuously. In this case, the kneading tank would be provided at one end of the tank of a manifold to feed the ingredients of the mixture or a pre-mixed product, and at the opposite end would be provided an outlet for discharging the kneaded mixture, e.g. on a conveyor belt. In operation, the same thrust exerted by the product entering the tank 7 would produce the advance of the mixture along the tank until it exits at the opposite end. In this way, a continuous loaf of mixture could be obtained at the outlet of the machine.

In theory, a variant using more than two kneading tools, parallel and side by side and co-operating with each other could also be provided. In regard to the solutions of FIGS. 7, 8 and 9, in which the arms 12B are arranged according to inclined directions, the inclination relative to the generatrix of the theoretical cylinder 12B can be in order of a few degrees (e.g. 4.5°) and in any case it is preferably no greater than 10°. The expression “slightly inclined” when used in the appended claims shall therefore be construed to indicate an angle not noticeably greater than 10°.

The section of each of the arms 12B is preferably quadrangular, but it can naturally also have different conformation. Lastly, the materials suitable for the construction of the kneading tools and of the tank will be chosen by those skilled in the art according to the notions generally known in the field. In a typical example, the two kneading tools are made of stainless steel.

Naturally, without altering the principle of the invention, the construction details and the embodiments may vary widely from what is described and illustrated purely by way of example herein, without thereby departing from the scope of the present invention.

For example, each kneading arm could have a slightly helical profile.

1. A kneading machine comprising:
a tank, and
at least two kneading tools (12) rotatable inside the tank around two substantially horizontal and parallel axes,
wherein:
the two kneading tools are rotatable around said axes with concurring directions of rotation,
the two kneading tools define, with their rotation, two theoretical cylinders, substantially tangential to each other,
each kneading tool has at least one arm,
said at least one arm extends substantially on the periphery of the respective theoretical cylinder, so that said arm performs an orbital movement around the respective axis of rotation,
each arm, at least for a substantial part of its length, is substantially rectilinear and positioned along a direction that substantially coincides with a generatrix of the respective theoretical cylinder, or is slightly inclined relative to said generatrix.

2. Kneading machine as claimed in claim 1, wherein said tank has a bottom, and in that the theoretical cylinders of the two kneading tools are tangential to said bottom.

3. Kneading machine as claimed in claim 2, wherein the tank has two substantially vertical longitudinal tangential to a respective longitudinal lateral wall.

4. Kneading machine as claimed in claim 3, wherein both theoretical cylinders are tangential to the respective longitudinal lateral walls of the tank lateral walls and in theoretical cylinders that at least one of said of the kneading tools is

5. Kneading machine as claimed in claim 3, wherein each longitudinal lateral wall of the tank is joined with the aforesaid bottom of the tank by means of a portion of curved wall, and in that the curved wall is substantially coaxial and immediately adjacent to a respective theoretical cylinder.

6. Kneading machine as claimed in claim 1, wherein it comprises means for actuating the rotation of the two kneading arms around the respective axes of rotation, able to cause said arms have orbital motions around the respective axes of rotation which are mutually synchronised, in such a way that the arms pass in substantially simultaneous fashion, or at close times, in the area of tangency of the respective theoretical cylinders, crossing with opposite directions of motion, because of the concurrent rotation of the two kneading tools.

7. Kneading machine as claimed in claim 6, wherein the two aforesaid theoretical cylinders have substantially equal diameter and substantially equal axial dimension, and in that the velocities of rotation of the two arms are also substantially equal.

8. Kneading machine as claimed in claim 1, wherein said tank has a longitudinal median plane, two longitudinal lateral walls positioned at equal distance from said longitudinal median plane and in that the two axes of rotation of the two kneading tools are also positioned at equal distance from said longitudinal median plane.

9. Kneading machine as claimed in claim 1, wherein the two theoretical cylinders have a diameter that is substantially equal to or slightly smaller than the distance of each lateral longitudinal wall of the tank from the longitudinal median plane of the tank.

10. Kneading machine as claimed in claim 1, wherein the two theoretical cylinders are distanced from the respective lateral walls of the tank by two mutually different distances.

11. Kneading machine as claimed in claim 1, wherein said tank is provided with a lid including manifolds for the introduction of the ingredients needed for the mixture.

12. Kneading machine as claimed in claim 11, wherein it is adapted to connect the inner cavity of the tank with a source of vacuum or of pressure.

13. Kneading machine as claimed in claim 1, wherein the wall of the tank includes a cooling jacket for the circulation of a cooling fluid.

14. Kneading machine as claimed in claim 1, wherein the two kneading arms have respective cutting edges which are mutually opposite when the two arms cross each other.

15. Kneading machine as claimed in claim 1, wherein the kneading arms have a section with quadrangular shape.

16. Kneading machine as claimed in claim 1, wherein the machine id adapted for batch operation and it is provided with means for emptying the tank.

17. Kneading machine as claimed in claim 16, wherein said emptying means provide means for supporting the tank in movable fashion between a position of normal use and an upset position for discharging the kneaded product.

18. Kneading machine as claimed in claim 17, wherein said emptying means include means for supporting the tank in swivelling fashion around a longitudinal axis parallel to the longitudinal direction of the tank, and motor means to actuate a rotation of the tank around said axis of rotation, between the position of normal use and the position for discharging the product.

19. Kneading machine as claimed in claim 1, wherein each kneading arm is connected at the ends of the two disks coaxial with the axis of rotation of the kneading tool and mounted rotatable two end walls of the tank.

20. Kneading machine as claimed in claim 1, wherein at each kneading arm is arranged according to a direction which is inclined, relative to a generatrix of the respective theoretical cylinder, by an angle of between 0° and 100.

21. Kneading machine as claimed in claim 1, wherein each kneading arm is arranged according to a broken line with two portions having an equal or opposite inclination relative to a generatrix of the respective theoretical cylinder.

22. Kneading machine as claimed in claim 1, wherein the aforesaid broken line defines an arrow oriented in the direction of rotation of the kneading tool.

23. Kneading machine as claimed in claim 21, wherein the aforesaid broken line defines an arrow oriented in a direction contrary to the direction of rotation of the kneading tool.

24. Kneading machine as claimed in claim 1, wherein it is adapted for continuous operation, with an elongated tank having an end for loading the ingredients necessary for the mixture or a pre-mixed product, and an opposite end for discharging the kneaded product, and in that the advance of the product along the tank is determined by the thrust exerted by the product entering the tank.
